(19) United States
(12) Patent Application Publication
(10) Pub. No.: US 2024/0320687 A1
(43) Pub. Date: Sep. 26, 2024

(54) Distributed Edge Application Compliance

(71) Applicant: International Business Machines Corporation, Armonk, NY (US)

(72) Inventors: Abdulhamid Adebowale Adebayo, White Plains, NY (US); Braulio Gabriel Dumba, White Plains, NY (US); Alexei Karve, Mohegan Lake, NY (US); Robert Filepp, Westport, CT (US); Andrew John Anderson, Stamford, CT (US)

(21) Appl. No.: 18/189,681

(22) Filed: Mar. 24, 2023

(51) Int. Cl. G06Q 30/018

(52) U.S. Cl. CPC G06Q 30/018

(57) ABSTRACT

A computer implemented method determines a compliance of an application. A number of processor units determines compliance scores resulting from compliance checks performed at each layer in layers in an edge computing network for components for the application running in the layers. The compliance checks performed at each layer are determined using a compliance profile identifying a set of the compliance checks for each component in the application. The number of processor units transmit the compliance scores determined in each layer in the layers upward to a top layer in the layers. The number of processor units aggregate compliance scores received from the components in a lower layer for transmission upward in the layers to the top layer as aggregated compliance scores. The number of processor units determine the compliance for the application using an overall aggregate score determined at the top layer.

### BACKGROUND

The disclosure relates generally to an improved computer system and more specifically to a computer implemented method, apparatus, system, and computer program product for obtaining compliance information for an application that has distributed workloads in an edge computing infrastructure.

Many companies are moving from a centralized cloud approach for computing to one that includes edge computing. Edge computing involves processing data and running applications closer to the source of data and the devices that generate this data. In other words, the data processing and analysis are performed at the edge of the network at or near devices that generate or access data. This network is also referred to as an edge computing network.

An application can be distributed through different layers of an edge computing network. With this type of application, distributed workloads are present. With distributed workloads, devices in the edge device layer include processes for the application that can perform data collection and processing or preprocessing of the data. These devices can be, for example, Internet of things (IoT) devices, sensors, wearable devices, autonomous vehicles, control systems, and other devices.

The data generated and processed by these devices can be sent upward in the hierarchy to a server layer that contains additional processes to perform these workloads such as aggregating data from devices in the edge device layer and additional data processing and analysis for the application. The processed data can then be sent upward to a cloud server layer a in which additional processes for the application can perform aggregation, additional processing, analysis, storage, and other operations on the data. As a result, this type of architecture takes into account the scalability and cost-effectiveness of cloud computing with low latency in real time capabilities with edge computing.

### SUMMARY

According to one illustrative embodiment, a computer implemented method determines a compliance of an application. A number of processor units determines compliance scores resulting from compliance checks performed at each layer in layers in an edge computing network for components for the application running in the layers. The compliance checks performed at each layer are determined using a compliance profile identifying a set of the compliance checks for each component in the application. The number of processor units transmit the compliance scores determined in each layer in the layers upward to a top layer in the layers. The number of processor units aggregate compliance scores received from the components in a lower layer for transmission upward in the layers to the top layer as aggregated compliance scores. The number of processor units determine the compliance for the application using an overall aggregate score determined at the top layer. According to other illustrative embodiments, a computer system and a computer program product for determining a compliance of an application are provided.

### BRIEF DESCRIPTION OF THE DRAWINGS

FIG. 1 is a block diagram of a computing environment in accordance with an illustrative embodiment;

FIG. 2 is a block diagram of an compliance environment in accordance with an illustrative embodiment;

FIG. 3 is an illustration of compliance profile creation in accordance with an illustrative embodiment;

FIG. 4 is an illustration of compliance checks associated with tags in accordance with an illustrative embodiment;

FIG. 5 is an illustration of dataflow in an edge computing network in accordance with an illustrative embodiment;

FIG. 6 is a flowchart of a process for determining compliance of an application in accordance with an illustrative embodiment;

FIG. 7 is a flowchart of a process for encryption in accordance with an illustrative embodiment;

FIG. 8 is a flowchart of a process for determining compliance scores in accordance with an illustrative embodiment;

FIG. 9 is a flowchart of a process for determining compliance scores in accordance with an illustrative embodiment;

FIG. 10 is a flowchart of a process for applying weights in aggregating compliance scores in accordance with an illustrative embodiment;

FIG. 11 is a flowchart of a process for determining statuses from compliance checks in accordance with an illustrative embodiment;

FIG. 12 is a flowchart of a process for aggregating statuses in accordance with an illustrative embodiment; and

FIG. 13 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

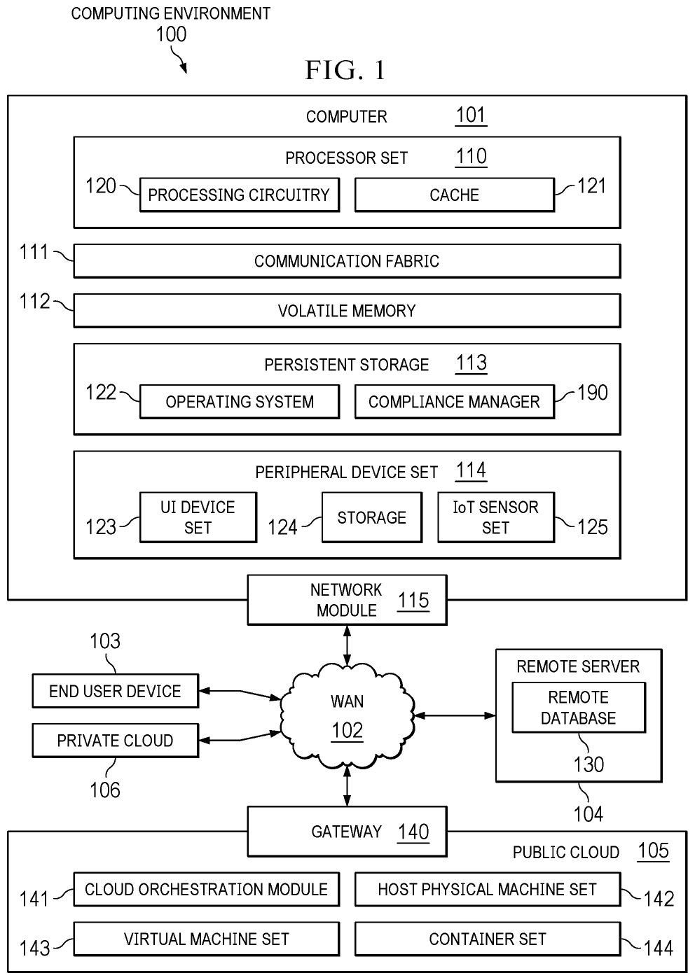

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as compliance manager 190. In addition to compliance manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and compliance manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in compliance manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in compliance manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative examples recognize and take into account a number of different considerations as described herein. With distributed applications in an edge computing network, some application components are extended or designed to run closer to a data source such as at the edge device later. With a distributed application, storage and processing functions can be distributed over multiple edge layers. Different types of application tasks can be performed at different layers in the edge computing network.

With this distributed processing and storage of data, increased complexity is present in ensuring the security of data handled by components of the application in different layers in the edge computing network. Different devices in different components can have different security policies that govern how data is handled. The different components are required to meet the security policies applicable to those components. For example, requirements, laws, and regulations are present for how data is stored and processed. These requirements, laws, regulations can also be different for different countries and industries.

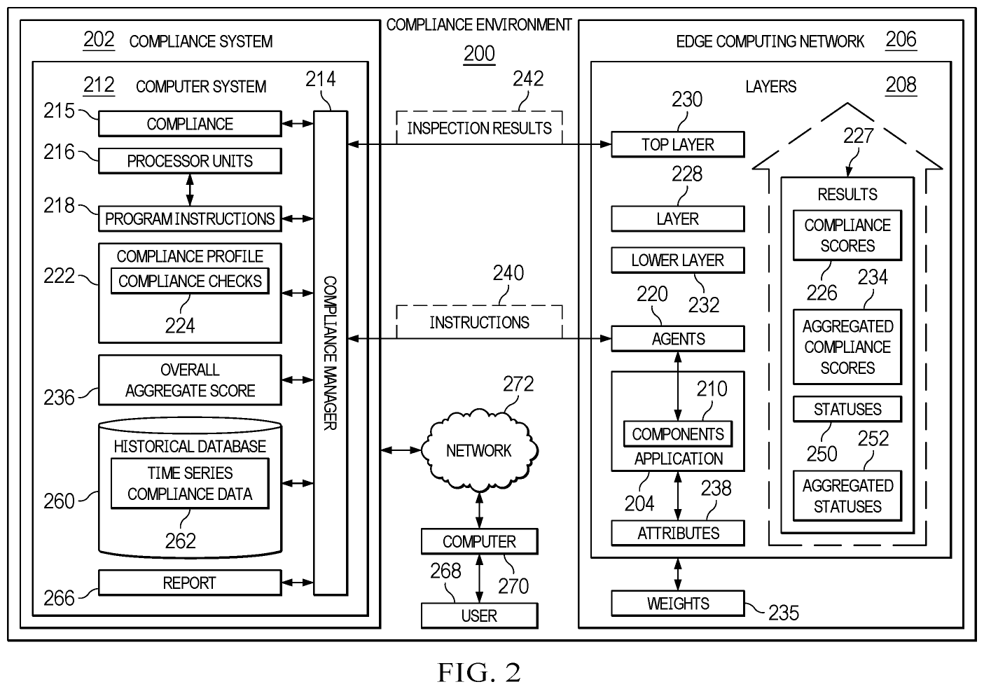

With reference now to FIG. 2, a block diagram of an compliance environment is depicted in accordance with an illustrative embodiment. In this illustrative example, compliance environment 200 includes components that can be implemented in hardware such as the hardware shown in computing environment 100 in FIG. 1.

In this illustrative example, compliance system 202 in compliance environment 200 operates to perform compliance checks on application 204. Application 204 runs in edge computing network 206. Edge computing network 206 is a hardware network comprised of hardware and software components organized into layers 208. The number of layers 208 present in edge computing network 206 can depend on the particular architecture. For example, different layers 208 in edge computing network 206 can comprise an edge devices layer, an edge server layer, and a cloud server layer. In other illustrative examples, edge computing network 206 can have numbers of layers other than three layers. In another example, edge computing network 206 can have top layer 230 as a cloud, three server layers, and an edge devices layer.

As depicted, application 204 is a distributed application and is comprised of components 210. Components 210 run in different layers in layers 208. In other words, not all of components 210 run on the same layers and layers 208.

Compliance manager 214 can be implemented in software, hardware, firmware or a combination thereof. When software is used, the operations performed by compliance manager 214 can be implemented in program instructions configured to run on hardware, such as a processor unit. When firmware is used, the operations performed by compliance manager 214 can be implemented in program instructions and data and stored in persistent memory to run on a processor unit. When hardware is employed, the hardware can include circuits that operate to perform the operations in compliance manager 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program instructions that operate a computer. A processor unit can be implemented using processor set 110 in FIG. 1.

When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different type of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this example, compliance manager 214 can determine compliance 215 of application 204, which is a distributed application. In this illustrative example, compliance 215 can take a number of different forms. For example, compliance 215 can be compliance with at least one of a security, data integrity, service level objectives (SLO), and other types of policies or objectives.

Compliance manager 214 determines compliance 215 of application 204 as an end-to-end process using compliance checks 224 that are performed individually on components 210 for application 204. For example, the compliance check performed on application 204 involves performing compliance checks 224 on components 210 for application 204 running in layers 208 in edge computing network 206. In this example, components 210 for application 204 are distributed through different layers and layers 208.

In this depicted example, compliance manager 214 determines compliance scores 226 resulting from compliance checks 224 performed at each layer in layers 208 in edge computing network 206 for components 210 for application 204 running in layers 208. These compliance scores are used to determine compliance 215 of application 204.

In this illustrative example, compliance manager 214 determines what compliance checks to perform for components 210 in using compliance profile 222. Compliance profile 222 comprises an identification of compliance checks 224 to be performed on components 210 in application 204. In other words, different components in components 210 can run different compliance checks in compliance checks 224.

In these examples, a compliance check is a rule and can include data to apply the rule. With a compliance check, the rule for the compliance check can be applied to a component in an application. This compliance check can be used to determine whether a particular control for the component passes the rule. The result of applying the rule can be at least one of the compliance score or status for the component. The status can be, for example, a pass or fail for the compliance check.

For example, a compliance check can be a rule that passwords have an age of at least 90 days. In this example, if the age of the password is less than 90 days, then compliance check fails. This requirement can be used to reduce potential issues of a recently compromised password.

As another example, a compliance check can be a rule that a password has to have at least 8 characters. When session logins are performed by components, the compliance check can determine the number of characters in the past were used to determine whether compliance is present for that compliance check.

In this example, a compliance score for a component can be a score based on the set of compliance checks 224 performed on that component. For example, if two compliance checks are performed for the component and one check passes and one check fails, the compliance or can be, for example, 0.5. In another example, if four compliance checks are performed on components and one compliance check fails while the other three compliance check pass, the score for that component is 0.75.

In this illustrative example, compliance manager 214 transmits compliance scores 226 determined for components 210 in each layer in layers 208 in results 227 upward to top layer 230 in the layers 208. Results 227 can be at least one of aggregated, analyzed, or otherwise processed to form inspection results 242 that are sent to compliance manager 214. In other words, all of compliance scores 226 determined in layer 228 are transmitted upward from the layer in which compliance scores 226 were determined for components 210 in the layer to another layer in layers 208. As a result, compliance scores 226 determined in different layers in layers 208 are transmitted upward to top layer 230.

As used herein, “a set of” when used with reference to items, means one or more items. For example, “a set of compliance scores” is one or more compliance scores.

This illustrative example, compliance manager 214 also aggregates compliance scores 226 received from components 210 in lower layer 232 for transmission upward in layers 208 to top layer 230. In this example, compliance scores 226 are transmitted as aggregated compliance scores 234 in results 227. This aggregation of compliance scores 226 can reduce the amount of data transmitted through edge computing network 206.

Additionally, compliance manager 214 can assign weights 235 to layer 228 in layers 208 based on a set of attributes 238 for a set of components 210 in layer 228. Attributes 238 can be the tasks or type of workloads that a component performs. For example, attributes 238 can be selected from at least one of data collection, storage, processing, inference, data summarization, model training, or other types of tasks or workloads.

In this example, compliance manager 214 determines overall aggregate score 236 in top layer 230. Additionally, compliance manager 214 encrypts compliance scores 226 and aggregated compliance scores 234 for transmission upward in layers 208. Compliance manager 214 determines compliance 215 for application 204 using overall aggregate score 236 in top layer 230.

In these illustrative examples, compliance manager 214 can perform these and other steps through sending instructions. For example, compliance manager 214 can send instructions 240 to agents 220 in layers 208 to perform compliance of at least one of a compliance check, an aggregation of compliance scores 226, or other operations. For example, instructions 240 can include sets of compliance checks 224 that are directed to different agents in agents 220.

Compliance checks 224 can be performed on components 210 by agents 220 based on attributes 238 for components 210. A set of compliance checks 224 can be performed on each component and components 210 based on the set of attributes 238 for each component in components 210.

Additionally, compliance manager 214 can receive inspection results 242 from top layer 230 in layers 208. In this example, inspection results 242 can include overall aggregate score 236, aggregated compliance scores 234 from lower layers, and aggregated statuses 252.

In this example, compliance manager 214 sends compliance checks 224 to agents 220. An agent in agents 220 is a process that can run a set of compliance checks 224 on a component in components 210 located in a layer in layers 208. The particular compliance checks in compliance checks 224 that are run on a component can be based on a set of attributes 238 for each component. The agent is configured to run compliance checks the component using on a set rules propagated to the agent from compliance manager 214.

In this illustrative example, compliance manager 214 can determine statuses 250 in addition to compliance scores 226. Statuses 250 identifies a status of compliance checks 224. In other words, a status can indicate whether a particular compliance check passed or failed for a component in a layer. Statuses 250 are transmitted upward through layers 208 as part of results 227. A set of statuses is determined in each layer in layers 208 and can be transmitted upward to top layer 230 in this illustrative example.

Further, in transmitting statuses 250 upward through layers 208, statuses 250 can be aggregated at each layer to form aggregated statuses 252. As depicted, aggregated statuses 252 are also transmitted upward through layers 208 in results 227. This aggregation of aggregated statuses 252 can reduce the amount of data transmitted through edge computing network 206.

In this illustrative example, compliance manager 214 can store inspection results 242 in historical database 260. Historical database 260 contains time series compliance data 262 from results received from prior testing of components 210 for application 204.

In this illustrative example, compliance manager 214 can automatically generate report 266 using inspection results 242 stored in historical database 260. This report can be sent to user 268 at computer 270 over network 272 for display to user 268. Network 272 can be, for example, at least one of the Internet, edge computing network 206, a local area network, a cloud, a wide area network, or some other suitable network.

Compliance manager 214 can automatically generate and send report 266 to a computer 270 for visualization by user 268 in response to an event. This event can be a request from the user, a receipt of inspection results 242, or some other suitable event.

In this illustrative example, report 266 can include an indication of whether compliance is present for application 204 as well as various other data from inspection results 242. In this illustrative example, report 266 can be a graphical visualization of inspection results 242 to enable easier comprehension of information in inspection results 242.

Additionally, in generating report 266, compliance manager 214 can also use other results in time series compliance data 262 for prior compliance testing of components 210 for application 204. These prior results can be used to provide a visualization of a trend of results obtained for application 204. These results can include a visualization of scores for components 210 in different layers and layers 208 over time.

Further, an identification of information such as classes of compliance checks 224 can be visualized. For example, a graphical visualization of scores and statuses for classes such as encryption, encryption at rest, session authentication, malicious code protection, and other types of compliance checks can be presented in graphical form in report 266. Additionally, an identification of trends of compliance for at least an application, components, or layers can be included in report 266. This information can aid user 268 in determining whether particular components or layers may be the result of a scores in inspection results 242.

In one illustrative example, one or more technical solutions are present that overcome a technical problem with determining compliance of a distributed application. As a result, one or more technical solutions may provide a technical effect that enables determining compliance of components in an application using compliance checks that are selected based on attributes of the components and what layers the components are located in the edge computing network.

In the illustrative examples, compliance checks can be performed for different components in different layers based on the tasks or workloads performed by these components. The compliance checks for different components are identified in a compliance profile for the application. This compliance profile is used to distribute instructions to perform tasks on the components in the layers where the components are located. The results of these tests are passed upward in the layers in the edge computing network to a top layer. The scores are analyzed to identify a score or the application. Additionally, the scores from the components can also be analyzed. Status of a component based on the compliance checks performed can also be in the layers.

With the status information on compliance checks, the status of component in the different layers can be identified. In this manner, components in which issues are present can be identified and analyzed. In the illustrative of examples, to reduce the amount of data sent from compliance tests, aggregation can be performed at each level as results from the compliance checks are sent upward through the layers.

Computer system 212 can be configured to perform at least one of the steps, operations, or actions described in the different illustrative examples using software, hardware, firmware or a combination thereof. As a result, computer system 212 operates as a special purpose computer system in which compliance manager 214 in computer system 212 enables performing compliance checks to determine compliance scores in which the compliance checks are performed in layers where components for an application are located in an edge computing network.

In the illustrative example, the use of compliance manager 214 in computer system 212 integrates processes into a practical application for determining compliance of an application that increases the performance of computer system 212. In these examples, the performances increased with computer system 212 being enabled to perform compliance checks that ensures enforcement of compliance for components for different layers in an edge computing network. In the illustrative examples, the compliance checks are performed at the locations where components are running in the layers in the edge computing network.

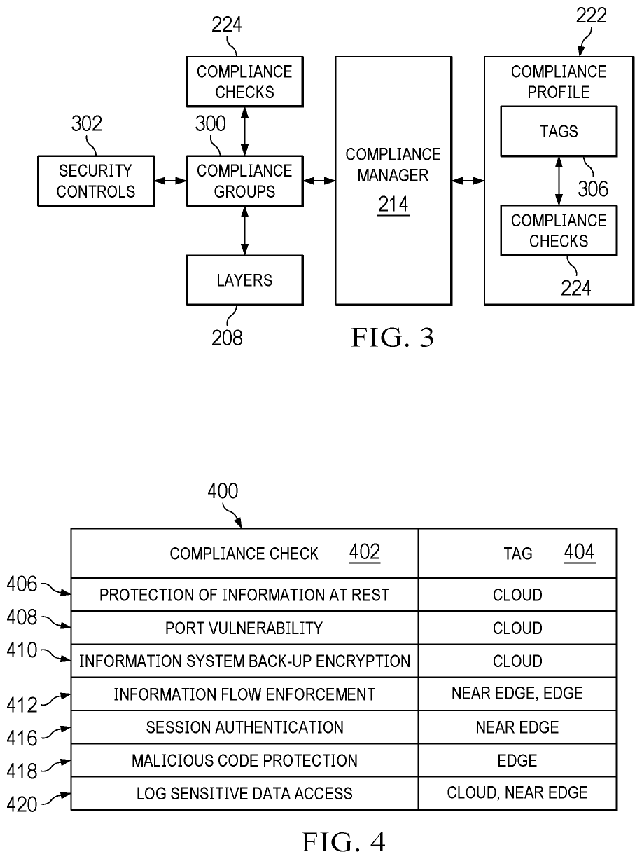

With reference next to FIG. 3, an illustration of compliance profile creation is depicted in accordance with an illustrative embodiment. In the illustrative examples, the same reference numeral may be used in more than one figure. This reuse of a reference numeral in different figures represents the same element in the different figures.

In this illustrative example, compliance manager identifies compliance groups 300 for compliance checks 224. These compliance groups can also be referred to as classes for compliance classes.

In this illustrative example, compliance groups 300 are for security controls 302 used in components 210 in application 204. In this illustrative example, compliance checks 224 are classified into compliance groups 300. In one illustrative example, a machine learning model can be used to classify compliance checks 224 into compliance groups 300. In yet another illustrative example, compliance groups 300 can be created and compliance checks 224 can then be formed or created for compliance groups 300.

In this illustrative example, compliance groups 300 can include, for example, storage encryption, encryption at rest, password configuration, vulnerability scanning, information system backup, information flow enforcement, session authentication, malicious code protection, sensitive data and other types of groups for security controls 302.

In the illustrative example, compliance manager 214 maps compliance groups to layers 208. This mapping can be based on attributes of the workload performed at each of layers 208. For example, regulations or standards regarding compliance can be identified for each of layers 208. The applicable groups in compliance groups 300 to each of layers 208 are identified. This identification can be made using, for example, regulations or standards for different layers and layers 208.

Compliance manager 214 associates tags 306 with compliance checks 224 based on the applicable groups in compliance groups 300 for layers 208. In this example, tags 306 can be identifications of layers. For example, tags 306 can be a cloud, near edge, and edge. This association of tags 306 with compliance checks 224 forms compliance profile 222. Compliance profile 222 can then be distributed to perform compliance checks. Agents in the different layers can identify which compliance checks in compliance checks 224 should be performed by those agents based on tags 306 and the corresponding location of the agents in layers 208.

The illustration of compliance environment 200 in the different components in FIGS. 2-3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, compliance manager 214 can manage compliance or one or more applications in addition to application 204. This compliance can be managed through having compliance profiles that are applicable to the additional applications.

With reference next to FIG. 4, an illustration of compliance checks associated with tags is depicted in accordance with an illustrative embodiment. In this illustrative example, table 400 is an example of compliance checks associated with tags in a compliance profile, such as compliance profile 222 in FIG. 2. In this example, table 400 includes two columns, compliance check 402 and tag 404. As depicted, these compliance checks rules can be applied to controls and components. Compliance check 402 is a column that identifies the compliance check to be performed. Tag 404 identifies the layer in which the compliance check should be performed.

In this example, row 406 has “protection of information at rest” as a compliance check that is to be performed in the cloud layer. In this example, “protection of information at rest” can be a rule identifying a cryptographic mechanism, integrity protection, or other control that is required to be used. This rule can be applied to the control in a component in the cloud layer to determine whether the control meets the rule.

Row 408 has “port vulnerability” that is a compliance check to be performed in the cloud layer. In this example, “port vulnerability” can be a rule for port configuration. The application of the rule can include scanning for or detecting ports that are not configured as specified in the rule.

Row 410 has “information system back-up encryption” as a compliance check that is to be performed in the cloud layer. In this example, “information system back-up encryption” can be a rule used to determine whether the encryption of backups is performed at a selected level of encryption. For example, the rule can specify that 256 bit encryption is required for transmitting backup data to a backup location.

In this example, row 412 “information flow enforcement” is a compliance check that is to be performed at the near edge layer and edge layer. As depicted, “information flow enforcement” can be a rule regarding the structuring of access control list to prevent unauthorized file access. “Session authentication” in row 416 is to be performed at the near edge layer. In this example, session authentication can be a compliance check regarding password length required for session logins.

Malicious code protection” in row 418 is a compliance check that is to be performed at the edge layer. This compliance check can define the frequency that a malicious code mechanism checks for updates to an antivirus signature definition. Additionally, “log sensitive data access” in row 420 is a compliance check for use in the cloud layer and the near edge layer. In this example, this compliance check is performed to determine whether users are logged when accessing sensitive data.

These compliance checks and their associated tags can be distributed through the different layers in an edge computing network. Agents or other processes that are configured to perform the compliance checks monitor for compliance checks with tags associated with their layer. For example, an agent in the near edge layer can monitor for compliance checks having a near edge tag to identify which compliance check to perform.

Illustration of table 400 in FIG. 4 is one illustrative example of information in a compliance profile. This illustration is not meant to limit the manner in which other illustrative examples can be implemented. For example, an application identifier can also be included when more than one application is present for compliance checks in the edge computing network.

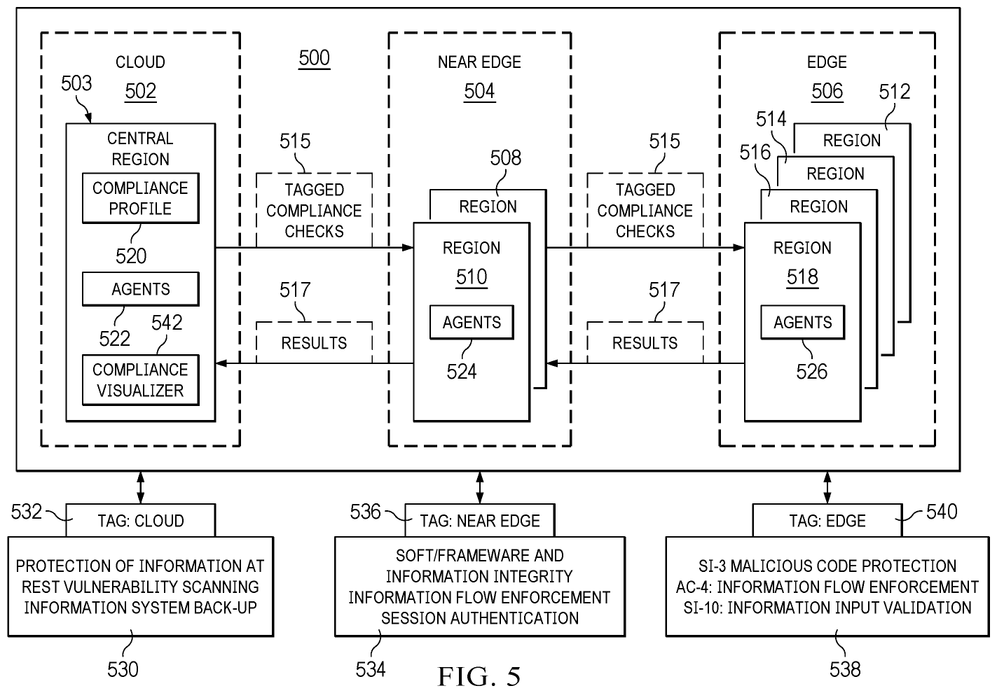

Turning next to FIG. 5, an illustration of dataflow in an edge computing network is depicted in accordance with an illustrative embodiment. In this illustrative example, edge computing network 500 is an example of edge computing network 206 in FIG. 2. As depicted, edge computing network 500 comprises cloud 502, near edge 504, and edge 506 as layers. Further, these layers can be divided into regions. For example, cloud 502 has central region 503, and near edge 504 has region 508 and region 510. In this example, edge 506 has region 512, region 514, region 516, and region 518.

For example, these different regions can be arranged in a hub and spoke arrangement. For example, central region 503 in cloud 502 can exchange data with region 508 and region 510 in near edge 504. Region 508 in near edge 504 can exchange data with region 512 and region 514 in edge 506, and region 510 in near edge 504 can exchange data with region 516 and region 518 in edge 506.

In this illustrative example, an application as components distributed through different layers in edge computing network 500. The components in the different layers can perform different types of workloads and processing data. For example, edge 506 can be used for inference, near edge 504 can be used for data summarization, and cloud 502 can be used for model training.

In this example, compliance profile 520 contains compliance checks associated with tags. These compliance checks with tags can be distributed as tagged compliance checks 515 within cloud 502 and from cloud 502 to near edge 504 and edge 506. The tags identify layers in which control checks is performed. These agents can monitor for projects in tagged compliance checks 515 that have tags for the layer in which the agents were located that perform the control checks. For example, agents 522 are located in cloud 502; agents 524 are located in near edge 504; and agents 526 are located in edge 506.

As depicted, compliance checks 530 associated with cloud 532 as a tag are examples of tagged compliance checks 515 that are performed by agents 522 in cloud 502. In this illustrative example, compliance checks 534 associated with near edge 536 as a tag are examples of tagged compliance checks 515 that are performed by agents 524 in near edge 504. Further in this example, compliance checks 534 associated with near edge 536 as a tag are examples of tagged compliance checks 515 that are performed by agents 524 in near edge 504. Additionally, compliance checks 538 associated with edge 540 as a tag are examples of tagged compliance checks 515 that are performed by agents 526 in edge 506.

In response to performing the compliance checks, the different agents in agents 220 return results 517 upward through the layers to cloud 502. As depicted, results 517 are encrypted for transmission through the layers up to cloud 502. In this manner, interception and altering of results 517 can be reduced or avoided. Additionally, results 517 can be aggregated by agents as results 517 are sent upward through the layers in edge computing network 500. For example, agents 524 in near edge 504 receiving results 517 from agents 526 in edge 506 can aggregate compliance scores in results 517. Agents 524 can then send any compliance scores generated by agents 524 as well as the aggregated compliance scores receive from agents 526 upward to cloud 502 in results 517.

In this illustrative example, results 517 can be processed to determine compliance for the application. In this example, compliance visualizer 542 can generate reports and display regarding compliance checks performed on the application. This visualization can include generating reports that display compliance of the application over time. For example, the compliance scores and status in results 517 can be stored and displayed as the time series data. Further, with compliance scores and status, the compliance of control checks for different groups can be visualized by a user on a display device.

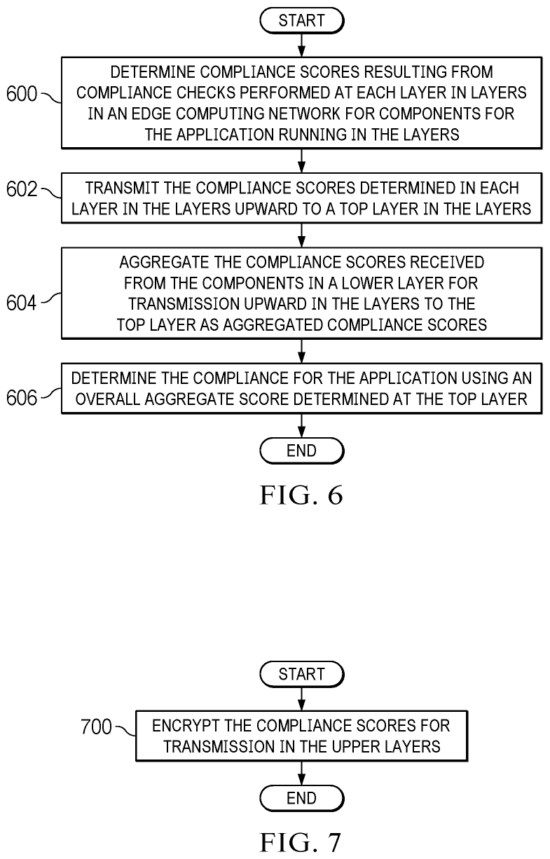

Turning next to FIG. 6, a flowchart of a process for determining compliance of an application is depicted in accordance with an illustrative embodiment. The process in FIG. 6 can be implemented in hardware, software, or both. When implemented in software, the process can take the form of program instructions that are run by one or more processor units located in one or more hardware devices in one or more computer systems. For example, the process can be implemented in compliance manager 214 in computer system 212 in FIG. 2.

The process determines compliance scores resulting from compliance checks performed at each layer in layers in an edge computing network for components for the application running in the layers (step 600). In step 600, the compliance checks performed at each layer are determined using a compliance profile identifying a set of the compliance checks for each component in the application.

The process transmits the compliance scores determined in each layer in the layers upward to a top layer in the layers (step 602). The process aggregates the compliance scores received from the components in a lower layer for transmission upward in the layers to the top layer as aggregated compliance scores (step 604).

The process determines the compliance for the application using an overall aggregate score determined at the top layer (step 606). The process terminates thereafter. In step 606, wherein the overall aggregate score (csₐ) is determined as follows:

$${cs}_{a} = {\sum }_{edge}^{E} {\sum }_{n}^{N} \frac{1}{N} {w}_{edge} * {cs}_{edge , n}$$

where E=set of edge layers, edge is an index, n is an index, w_{edge} is a weight assigned to a layer such that Σ_{edge}^{E} w_{edge}=1, N is a total number of nodes at a layer, and cs_{edge,n} is a compliance score for a node in a layer. For example, a node is a device on which a component for the application runs.

With reference now to FIG. 7, a flowchart of a process for encryption is depicted in accordance with an illustrative embodiment. The process illustrated in FIG. 7 is an example of an additional step that can be performed with the steps in FIG. 6.

The process encrypts the compliance scores for transmission in the upper layers (step 700). The process terminates thereafter.

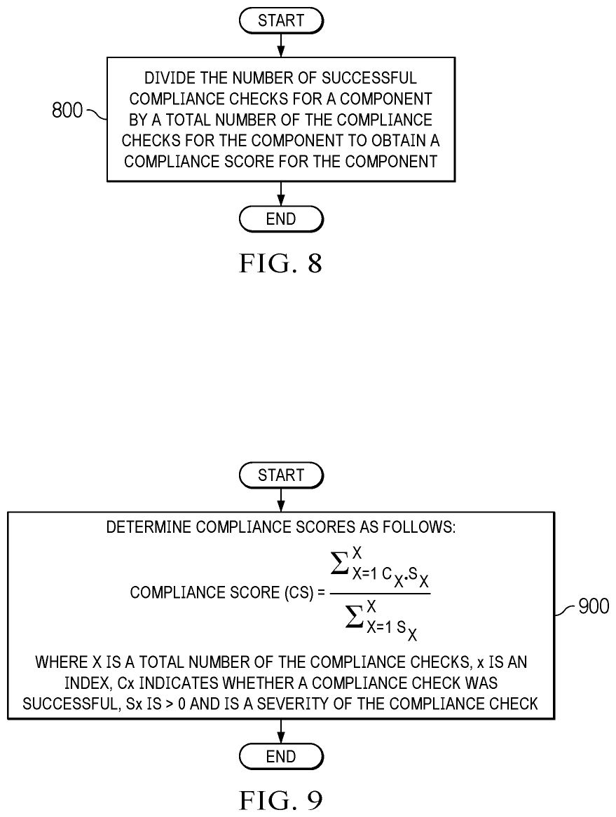

Turning to FIG. 8, a flowchart of a process for determining compliance scores is depicted in accordance with an illustrative embodiment. The process illustrated in FIG. 8 is an example of an implementation for step 600 in FIG. 6.

The process divides the number of successful compliance checks for a component by a total number of the compliance checks for the component to obtain a compliance score for the component (step 800). The process terminates thereafter. This process can be performed for each of the components in an application for which compliance is being determined.

In FIG. 9, a flowchart of a process for determining compliance scores is depicted in accordance with an illustrative embodiment. The process illustrated in FIG. 8 is an example of an implementation for step 600 in FIG. 6.

The process determines compliance scores as follows:

$$compliance score ( cs ) = \frac{{\sum }_{x = 1}^{X} {c}_{x} . {s}_{x}}{{\sum }_{x = 1}^{X} {s}_{x}}$$

where X is a total number of the compliance checks, x is an index, cₓ indicates whether a compliance check was successful, sₓ is >0 and is a severity of the compliance check (step 900). The process terminates thereafter.

In this illustrative example, the severity indicates the importance of the compliance check. The severity becomes higher as the importance of the compliance check becomes more important. In this manner, severity can be used to apply a weighting for the passing or failing of individual compliance checks in the compliance score.

For example, a compliance check for the presence of database encryption can be considered to be of “high” severity, but a layer that does not have a database can have lower weight relative to those layers with databases. The selection of severity levels can be performed in a number of different ways. For example, severity can be ranked as follows: high (3) in which a failure indicates a compromise; medium (2) in which a failure indicates the presence of a known malicious behavior signifying a likely compromise; and low (1) in which failure indicates a suspicious behavior that may or may not be malicious. These rankings can be converted into values for use in determining the compliance score.

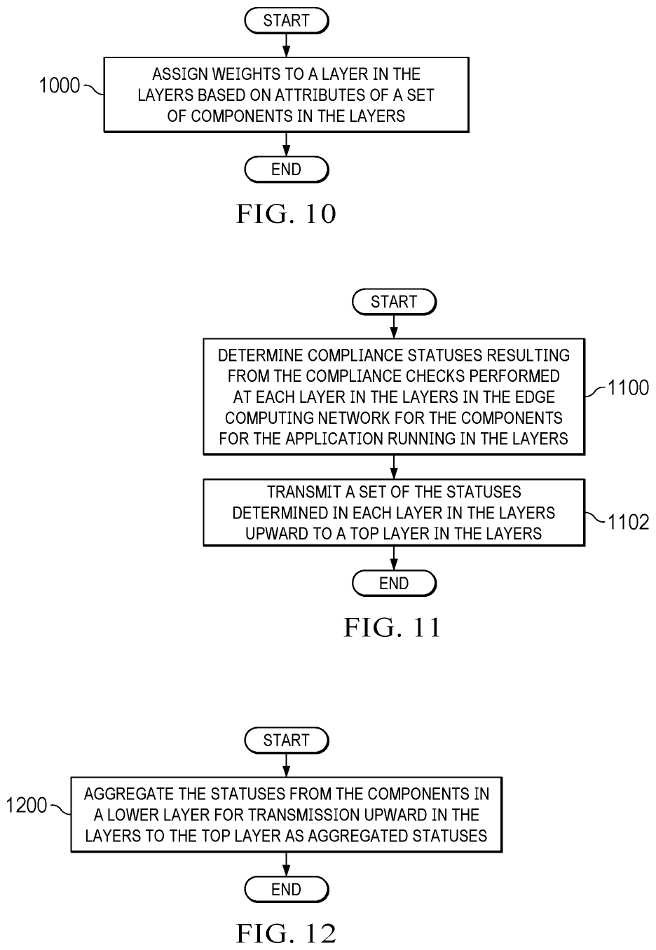

With reference to FIG. 10, a flowchart of a process for applying weights in aggregating compliance scores is depicted in accordance with an illustrative embodiment. The process illustrated in FIG. 10 is an example of a step that can be performed in step 604 in FIG. 6.

The process assigns weights to a layer in the layers based on attributes of a set of components in the layers (step 1000). The process terminates thereafter.

Turning next to FIG. 11, a flowchart of a process for determining statuses from compliance checks is depicted in accordance with an illustrative embodiment. The process illustrated in FIG. 11 is an example of additional steps that can be performed with the steps in FIG. 6.

The process determines compliance statuses resulting from the compliance checks performed at each layer in the layers in the edge computing network for the components for the application running in the layers (step 1100). The process transmits a set of the statuses determined in each layer in the layers upward to a top layer in the layers (step 1102). The process terminates thereafter.

In FIG. 12, a flowchart of a process for aggregating statuses is depicted in accordance with an illustrative embodiment. The step illustrated in FIG. 12 is an additional step that can be performed with the steps in FIG. 11.

The process aggregates the statuses from the components in a lower layer for transmission upward in the layers to the top layer as aggregated statuses (step 1200). The process terminates thereafter.

The aggregation in step 1200 can be performed in a number of different ways. For example, the aggregation can be based on received from agents in nodes. In one illustrative example, the aggregation can be performed on a per node basis. In this example, the nodes represent data processing or computing devices in a layer.

For example, with a 3 layer edge computing network, a top layer, L1, is a cloud layer. The second layer, L2, is near edge, and the third layer, L3, is edge. In this edge computing network. L1 has one node N, L2 has two nodes, A and B. Further, L3 has 20 nodes, 1-20. This edge computing network is set up as a hub and spoke configuration. In this example, nodes 1-10 in L3 send data to node A in L2 and node 11-20 in L3 send data to node B in L2. Both node A and node B in L2 send data to node N in L1. Further, the number of nodes in L3 can be greater than 20. In this example, nodes 11-20 of the nodes containing components which compliance checks are performed.

In one example, the compliance check is CC1: “Minimum password length”. This compliance check is applicable to nodes in L3. Node A receives a status and compliance score from nodes 1-10, while node B receives a status for from nodes 11-20. The statuses received are in the form of a pass or fail in these examples.

In this example, nodes 1-5 send a status of pass while nodes 6-10 send a status of fail for the compliance test. Nodes 11-17 send a status of pass and nodes 18-20 send a status of fail to node B. The aggregation of this information by node A is as follows: CC1: Pass-L3(5) and CC2: Fail-L3(5). The aggregation of status by node B can be CC1: Pass-L3(7) and CC2: Fail-L3(3). This reduces the amount of information that is sent up to node N in L1. In this example, CC2 is another compliance check in addition to CC1. This compliance check can be, for example, an age of the password.

If the compliance check CC1 is also applicable to L2 and node A and node B passes the compliance check, node A sends following to node N in L1 as follows: CC1: Pass-L3(5), L2(1) and CC2: Fail-L3(5). In a similar fashion, node B sends the following to node N in L1 as follows: CC1: Pass-L3(7), L2(1) and CC2: Fail-L3(3). This aggregation reduces the amount of information that is set up to node N in L1, reducing bandwidth usage within the edge computing network.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

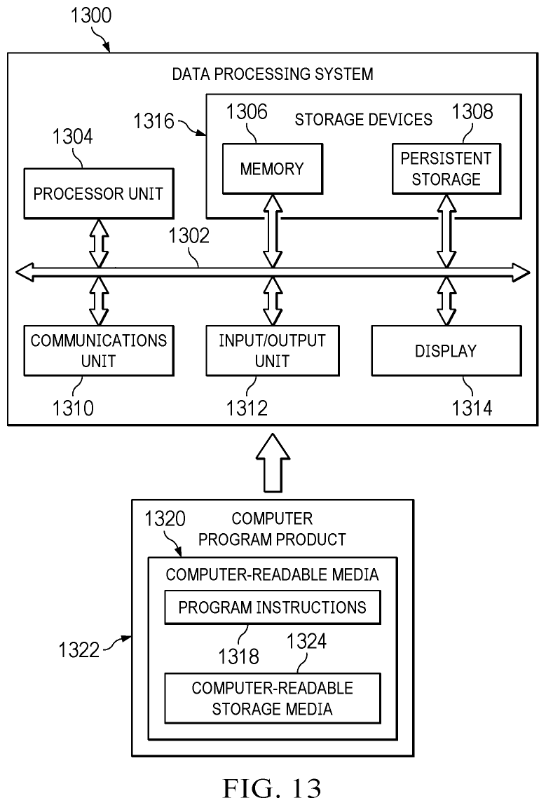

Turning now to FIG. 13, a block diagram of a data processing system is depicted in accordance with an illustrative embodiment. Data processing system 1300 can be used to implement computers and computing devices in computing environment 100 in FIG. 1. Data processing system 1300 can also be used to implement computer system 212 in FIG. 2. In this illustrative example, data processing system 1300 includes communications framework 1302, which provides communications between processor unit 1304, memory 1306, persistent storage 1308, communications unit 1310, input/output (I/O) unit 1312, and display 1314. In this example, communications framework 1302 takes the form of a bus system.

Processor unit 1304 serves to execute instructions for software that can be loaded into memory 1306. Processor unit 1304 includes one or more processors. For example, processor unit 1304 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1304 can be implemented using one or more heterogeneous processor systems in which a main processor is present with secondary processors on a single chip. As another illustrative example, processor unit 1304 can be a symmetric multi-processor system containing multiple processors of the same type on a single chip.

Memory 1306 and persistent storage 1308 are examples of storage devices 1316. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1316 may also be referred to as computer readable storage devices in these illustrative examples. Memory 1306, in these examples, can be, for example, a random-access memory or any other suitable volatile or non-volatile storage device. Persistent storage 1308 may take various forms, depending on the particular implementation.

For example, persistent storage 1308 may contain one or more components or devices. For example, persistent storage 1308 can be a hard drive, a solid-state drive (SSD), a flash memory, a rewritable optical disk, a rewritable magnetic tape, or some combination of the above. The media used by persistent storage 1308 also can be removable. For example, a removable hard drive can be used for persistent storage 1308.

Communications unit 1310, in these illustrative examples, provides for communications with other data processing systems or devices. In these illustrative examples, communications unit 1310 is a network interface card.

Input/output unit 1312 allows for input and output of data with other devices that can be connected to data processing system 1300. For example, input/output unit 1312 may provide a connection for user input through at least one of a keyboard, a mouse, or some other suitable input device. Further, input/output unit 1312 may send output to a printer. Display 1314 provides a mechanism to display information to a user.

Instructions for at least one of the operating system, applications, or programs can be located in storage devices 1316, which are in communication with processor unit 1304 through communications framework 1302. The processes of the different embodiments can be performed by processor unit 1304 using computer-implemented instructions, which may be located in a memory, such as memory 1306.

These instructions are referred to as program instructions, computer usable program instructions, or computer readable program instructions that can be read and executed by a processor in processor unit 1304. The program instructions in the different embodiments can be embodied on different physical or computer readable storage media, such as memory 1306 or persistent storage 1308.

Program instructions 1318 are located in a functional form on computer readable media 1320 that is selectively removable and can be loaded onto or transferred to data processing system 1300 for execution by processor unit 1304. Program instructions 1318 and computer readable media 1320 form computer program product 1322 in these illustrative examples. In the illustrative example, computer readable media 1320 is computer readable storage media 1324.

Computer readable storage media 1324 is a physical or tangible storage device used to store program instructions 1318 rather than a medium that propagates or transmits program instructions 1318. Computer readable storage media 1324, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1318 can be transferred to data processing system 1300 using a computer readable signal media. The computer readable signal media are signals and can be, for example, a propagated data signal containing program instructions 1318. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media” 1320 can be singular or plural. For example, program instructions 1318 can be located in computer readable media 1320 in the form of a single storage device or system. In another example, program instructions 1318 can be located in computer readable media 1320 that is distributed in multiple data processing systems. In other words, some instructions in program instructions 1318 can be located in one data processing system while other instructions in program instructions 1318 can be located in one data processing system. For example, a portion of program instructions 1318 can be located in computer readable media 1320 in a server computer while another portion of program instructions 1318 can be located in computer readable media 1320 located in a set of client computers.

The different components illustrated for data processing system 1300 are not meant to provide architectural limitations to the manner in which different embodiments can be implemented. In some illustrative examples, one or more of the components may be incorporated in or otherwise form a portion of, another component. For example, memory 1306, or portions thereof, may be incorporated in processor unit 1304 in some illustrative examples. The different illustrative embodiments can be implemented in a data processing system including components in addition to or in place of those illustrated for data processing system 1300. Other components shown in FIG. 13 can be varied from the illustrative examples shown. The different embodiments can be implemented using any hardware device or system capable of running program instructions 1318.

Thus, illustrative embodiments of the present invention provide a computer implemented method, computer system, and computer program product for determining a compliance of an application. A number of processor units determines compliance scores resulting from compliance checks performed at each layer in layers in an edge computing network for components for the application running in the layers. The compliance checks performed at each layer are determined using a compliance profile identifying a set of the compliance checks for each component in the application. The number of processor units transmit the compliance scores determined in each layer in the layers upward to a top layer in the layers. The number of processor units aggregate compliance scores received from the components in a lower layer for transmission upward in the layers to the top layer as aggregated compliance scores. The number of processor units determine the compliance for the application using an overall aggregate score determined at the top layer.

As result, the illustrative examples enable determining compliance for an application having components distributed within an edge computing network. In the illustrative examples, compliance checks can be performed for different components in different layers based on the tasks or workloads performed by these components. The compliance checks for different components are identified in a compliance profile for the application. This compliance profile is used to distribute instructions to perform tasks on the components in the layers where the components are located. The results of these tests are passed upward in the layers in the edge computing network to a top layer. The scores are analyzed to identify a score or the application. Additionally, the scores from the components can also be analyzed. The status of a component based on the compliance checks performed can also be determined in the layers. With the status information, the status of component in the different layers can be identified. In this manner, components in which issues are present can be identified and analyzed. In the illustrative of examples, to reduce the amount of data sent from compliance tests, aggregation can be performed at each level as results from the compliance checks are sent upward through the layers.

These results can be saved over time to form historical compliance data for the application. With the historical data, the time series analysis can be formed regarding the compliance of the application over time. The historical data can also include the status of components at different levels. With this historical data, an identification of components or types of components having issues or causing a compliance score to become lower can be identified.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for determining a compliance of an application, the computer implemented method comprising:
determining, by a number of processor units, compliance scores resulting from compliance checks performed at each layer in layers in an edge computing network for components for the application running in the layers, wherein the compliance checks performed at each layer are determined using a compliance profile identifying a set of the compliance checks for each component in the application;
transmitting, by the number of processor units, the compliance scores determined in each layer in the layers upward to a top layer in the layers;
aggregating, by the number of processor units, the compliance scores received from the components in a lower layer for transmission upward in the layers to the top layer as aggregated compliance scores; and
determining, by the number of processor units, the compliance for the application using an overall aggregate score determined at the top layer.

2. The computer implemented method of claim 1 further comprising:
encrypting, by the number of processor units, the compliance scores for transmission upward in the layers.

3. The computer implemented method of claim 1, wherein determining, by the processor units, the compliance scores comprises:
dividing a number of successful compliance checks for a component by a total number of the compliance checks for the component.

4. The computer implemented method of claim 1, wherein determining, by the processor units, the compliance scores comprises:
determining a compliance score for each component as follows:
$$compliance score ( cs ) = \frac{{\sum }_{x = 1}^{X} {c}_{x} . {s}_{x}}{{\sum }_{x = 1}^{X} {s}_{x}}$$
where X is a total number of the compliance checks, x is an index, cₓ indicates whether a compliance check was successful, sₓ is >0 and is a severity of the compliance check.

5. The computer implemented method of claim 1, wherein the overall aggregate score is determined as follows:
$${cs}_{a} = {\sum }_{edge}^{E} {\sum }_{n}^{N} \frac{1}{N} {w}_{edge} * {cs}_{edge , n}$$
where E=set of edge layers, edge is an index, n is an index, w_{edge} is a weight assigned to a layer such that Σ_{edge}^{E} w_{edge}=1, N is a total number of instances at a layer, and
cs_{edge,n} is a compliance score for an instance in a layer.

6. The computer implemented method of claim 1, wherein aggregating, by the processor units, the compliance scores comprises:
assigning, by the number of processor units, weights to a layer in the layers based on attributes of a set of the components in the layer.

7. The computer implemented method of claim 1, wherein the set of the compliance checks for each component is selected based on a set of attributes for each component.

8. The computer implemented method of claim 1 further comprising:
determining, by the number of processor units, compliance statuses resulting from the compliance checks performed at each layer in the layers in the edge computing network for the components for the application running in the layers; and
transmitting, by the number of processor units, a set of the compliance statuses determined in each layer in the layers upward to a top layer in the layers.

9. The computer implemented method of claim 8 further comprising:
aggregating, by the number of processor units, the compliance statuses from the components in a lower layer for transmission upward in the layers to the top layer as aggregated statuses.

10. A computer system comprising:
a number of processor units, wherein the number of processor units executes program instructions to:
determine compliance scores resulting from compliance checks performed at each layer in layers in an edge computing network for components for an application running in the layers, wherein the compliance checks performed at each layer are determined using a compliance profile identifying a set of the compliance checks for each component in the application;
transmit the compliance scores determined in each layer in the layers upward to a top layer in the layers;
aggregate the compliance scores received from the components in a lower layer for transmission upward in the layers to the top layer as aggregated compliance scores; and
determine the compliance for the application using an overall aggregate score determined at the top layer.

11. The computer system of claim 10, wherein the number of processor units further executes program instructions to:
encrypt the compliance scores for transmission upward in the layers.

12. The computer system of claim 10, wherein in determining the compliance scores, the number of processor units further executes program instructions to:
divide a number of successful compliance checks for a component by a total number of the compliance checks for the component.

13. The computer system of claim 10, wherein in determining the compliance scores, the number of processor units further executes program instructions to:
determine a compliance score for each component as follows:
$$compliance score ( cs ) = \frac{{\sum }_{x = 1}^{X} {c}_{x} . {s}_{x}}{{\sum }_{x = 1}^{X} {s}_{x}}$$
where X is a total number of the compliance checks, x is an index, cₓ indicates whether a compliance check was successful, sₓ is >0 and is a severity of the compliance check.

14. The computer system of claim 10, wherein the overall aggregate score is determined as follows:
$${cs}_{a} = {\sum }_{edge}^{E} {\sum }_{n}^{N} \frac{1}{N} {w}_{edge} * {cs}_{edge , n}$$
where E=set of edge layers, edge is an index, n is an index, w_{edge} is a weight assigned to a layer such that Σ_{edge}^{E} w_{edge}=1, N is a total number of instances at a layer, and cs_{edge,n} is a compliance score for an instance in a layer.

15. The computer system of claim 10, wherein in aggregating the compliance scores, the number of processor units further executes program instructions to:
assign weights to a layer in the layers based on attributes of a set of the components in the layer.

16. The computer system of claim 10, wherein the set of the compliance checks for each component is selected based on a set of attributes for each component.

17. The computer system of claim 10, wherein the number of processor units further executes program instructions to:
determine compliance statuses resulting from the compliance checks performed at each layer in the layers in the edge computing network for the components for the application running in the layers; and
transmit a set of the compliance statuses determined in each layer in the layers upward to a top layer in the layers.

18. The computer system of claim 17, wherein the number of processor units further executes program instructions to:
aggregate the compliance statuses from the components in a lower layer for transmission upward in the layers to the top layer as aggregated statuses.

19. A computer program product for determining compliance of an application, the computer program product comprising a computer readable storage medium having program instructions embodied therewith, the program instructions executable by a computer system to cause the computer system to:
determine compliance scores resulting from compliance checks performed at each layer in layers in an edge computing network for components for the application running in the layers, wherein the compliance checks performed at each layer are determined using a compliance profile identifying a set of the compliance checks for each component in the application;
transmit the compliance scores determined in each layer in the layers upward to a top layer in the layers;
aggregate the compliance scores received from the components in a lower layer for transmission upward in the layers to the top layer as aggregated compliance scores; and
determine the compliance for the application using an overall aggregate score determined at the top layer.

20. The computer program product of claim 19, wherein the program instructions are further executable by a computer system to cause the computer system to:
encrypt the compliance scores for transmission upward in the layers.
